(19) United States
(12) Patent Application Publication
(10) Pub. No.: US 2009/0026729 A1
(43) Pub. Date: Jan. 29, 2009

(54) FOOT BOARD ASSEMBLY

(75) Inventors: Jesse G. James, Surfside, CA (US); Michael Desmond, Long Beach, CA (US)

Correspondence Address: FITCH EVEN TABIN AND FLANNERY, 120 SOUTH LA SALLE STREET, SUITE 1600, CHICAGO, IL, 60603-3406, US

(73) Assignee: WEST COAST CHOPPERS, INC., Long Beach, CA (US)

(21) Appl. No.: 12/176,140

(22) Filed: Jul. 18, 2008

Related U.S. Application Data
(60) Provisional application No. 60/951,939, filed on Jul. 25, 2007.

(51) Int. Cl. B62J 25/00

(52) U.S. Cl. 280/291

(57) ABSTRACT

A foot board assembly includes an upper plate and a lower plate forming a box-like structure that has greater strength, yet is relatively light in weight. A plurality of openings extends through the upper and lower plates and provides an aesthetically-pleasing appearance. A band is attached to the outer edges of the upper and lower plates. This provides structural strength and forms an outer wall with a plurality of upward-extending teeth thereby allowing for safety and grip for an operator's foot.

### CROSS REFERENCE TO RELATED APPLICATIONS

This claims priority from U.S. Provisional Application No. 60/951,939, filed Jul. 25, 2007, which such application is incorporated herein by reference as if fully set forth herein.

### FIELD OF THE INVENTION

This generally relates to the field of foot boards for vehicles, and especially for motorcycles.

### BACKGROUND

Some vehicle designs involve the use of foot boards. For example certain motorcycles use foot boards that are attached to the lower part of the cycle frames. Such a foot board provides an operator or passenger with a platform upon which to place his/her feet while operating the motorcycle. Most known designs involve the use of a foot board that is constructed of a single layer or plate of metal.

### SUMMARY OF THE ILLUSTRATED EMBODIMENTS

According to one embodiment of the invention, a foot board assembly includes an upper plate and a lower plate forming a box-like structure that has greater strength, yet is relatively light in weight. A plurality of openings extends through the upper and lower plates and provides an aesthetically-pleasing appearance. A band is attached to the outer edges of the upper and lower plates. This provides structural strength and forms an outer wall with a plurality of upward-extending teeth thereby allowing for safety and grip for an operator's foot.

In one aspect, the foot board assembly is generally box-shaped and comprises a first plate that is dimensioned to support an operator's foot, wherein the first plate has a first plate outer edge and a first plate inner edge. A second plate is disposed in a spaced-apart relationship from the first plate and has a second plate outer edge and a second plate inner edge. A band member is connected to the first and second plate outer edges.

In another aspect, the first plate defines a first plate opening having a shape comprising a decorative indicia. The second plate defines a second plate opening that is in register with the first plate opening.

In another aspect, the first plate includes an inner surface disposed proximate to the second plate and an outer surface disposed distal to the second plate. The band member extends above the outer surface and includes a plurality of teeth also extending above the first plate outer surface.

In another aspect, the first plate includes a first plate projection, and the second plate includes a second plate projection. The band member defines a first opening dimensioned to receive at least a portion of the first plate projection, and further defines a second opening dimensioned to receive at least a portion of the second plate projection.

In another aspect, a spacer member is disposed between the first plate and the second plate and connected to each of them. The spacer member is generally longitudinal in shape and defines an opening at one end that is dimensioned for engagement onto a motorcycle.

In an alternative embodiment, a method of making a foot board assembly is disclosed. A band member is attached to an outer edge of a first plate. Also, the band member is attached to an outer edge of a second plate. A spacer member is attached to the first plate and to the second plate so that the spacer member is disposed between them. The first plate is thus disposed in a spaced-apart relationship with the second plate

There are additional aspects to the present inventions. It should therefore be understood that the preceding is merely a brief summary of some embodiments and aspects of the present inventions. Additional embodiments and aspects are referenced below. It should further be understood that numerous changes to the disclosed embodiments can be made without departing from the spirit or scope of the inventions. The preceding summary therefore is not meant to limit the scope of the inventions. Rather, the scope of the inventions is to be determined by appended claims and their equivalents.

### BRIEF DESCRIPTION OF THE DRAWINGS

These and/or other aspects and advantages of the present invention will become apparent and more readily appreciated from the following description of certain embodiments, taken in conjunction with the accompanying drawings of which:

FIG. 1 is a perspective view of a motorcycle foot board according to an embodiment of the invention;

FIG. 2 is a top plan view of the motorcycle foot board of FIG. 1;

FIG. 3 is a bottom plan view of the motorcycle foot board of FIG. 1;

FIG. 4 is a side elevation view of the motorcycle foot board of FIG. 1;

FIGS. 5a-5e illustrate the pre-assembled version of certain component parts of the motorcycle foot board of FIG. 1; and

FIG. 6 is a simplified process flow diagram for a method of making a foot board assembly in accordance with one embodiment of the invention.

### DETAILED DESCRIPTION

The following description is of the best mode presently contemplated for carrying out the invention. Reference will be made in detail to embodiments of the present invention, examples of which are illustrated in the accompanying drawings, wherein like reference numerals refer to like elements throughout. It is understood that other embodiments may be used and structural and operational changes may be made without departing from the scope of the present invention.

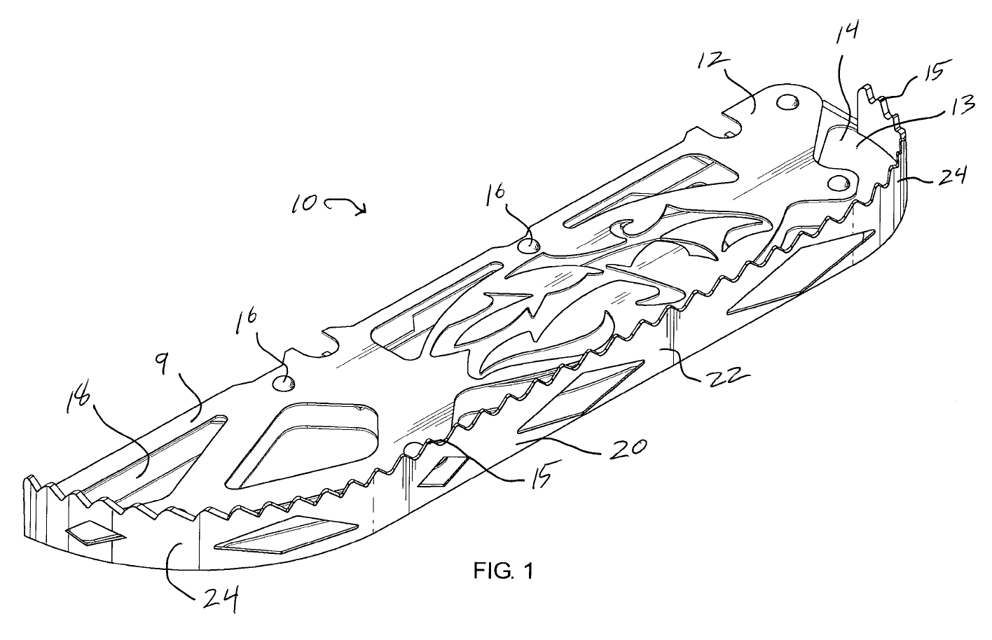

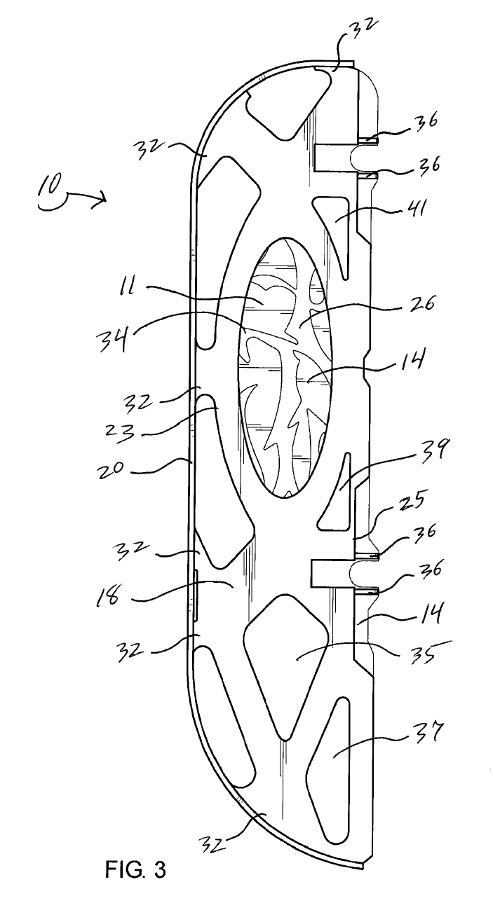

FIG. 1 shows a motorcycle foot board assembly 10 in accordance with one embodiment of the invention. While the illustrated foot board assembly 10 is for use with motorcycles, alternative embodiments of the invention can be for use with other vehicles, such as for example tricycles, bicycles, automobiles, etc. The foot board assembly 10 of FIG. 1 includes a first or top plate 14 and a second or bottom plate 18 disposed beneath the top plate 14 in a generally parallel, spaced-apart relationship from it. The top plate 14 has a lower or inner surface 11 (FIG. 3) that is disposed proximate to the bottom plate 18 and an upper or outer surface 13 that is disposed distal to the bottom plate 18. A third or cap plate 12 is disposed on the top plate outer surface 13 and is attached to the top plate 14 with a plurality of bolts 16.

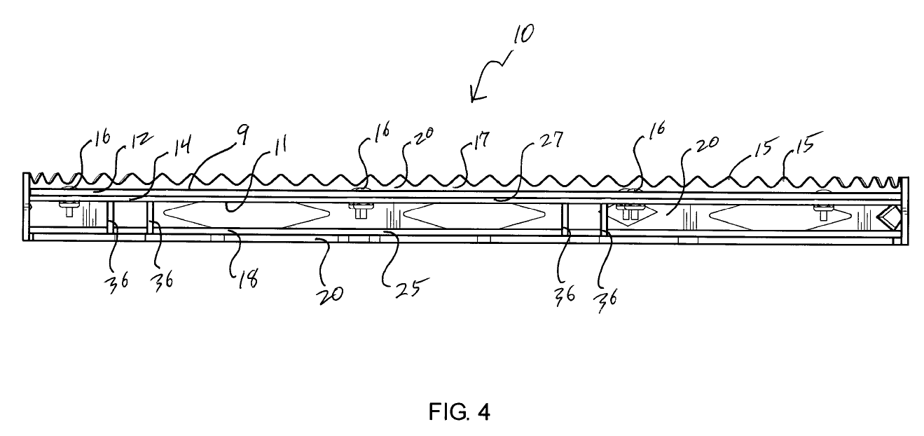

A strip or band member 20 is comprised of a generally straight center portion 22 disposed between two generally-curved, end portions 24. The band member 20 is sized and formed to abut the outer periphery or edge of each of the top and bottom plates 14, 18 and is welded or otherwise connected to the top and bottom plates 14, 18 thereby forming a generally box-shaped structure and providing structural strength. The band member 20 further includes a plurality of ridges or teeth 15 extending upward along one edge, so that the teeth 15 and a portion of the band member 20 extend above the outer surface 13 of the top plate 14 and above an outer surface 9 of the cap plate 12 thereby forming an outer wall 17 about the outer periphery of the top plate 14, bottom plate 18 and cap plate 12 as best seen in FIG. 4. The wall 17 and the teeth 15 provide safety and grip for an operator's foot.

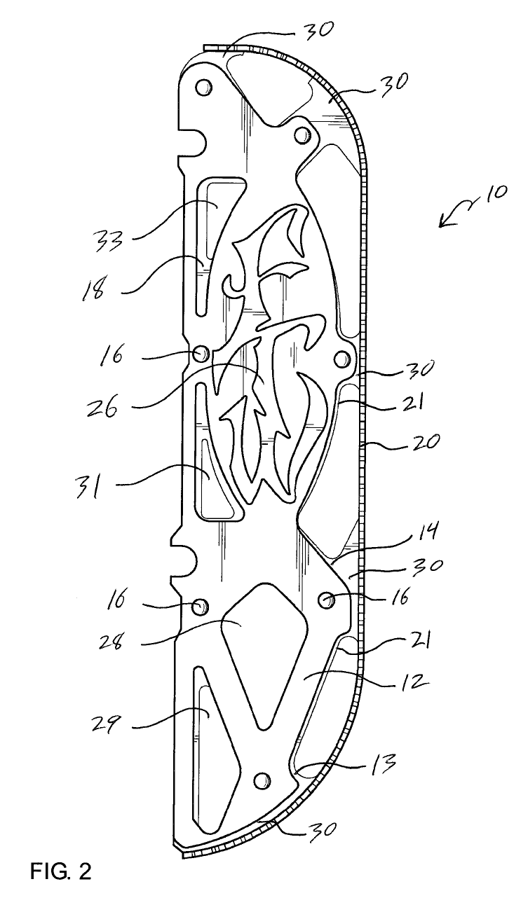

FIGS. 2 and 3 show respectively top and bottom plan views of the foot board assembly 10 of FIG. 1. The cap plate 12 is constructed of shiny stainless steel or chrome and is provided for ornamental purposes. Accordingly, the cap plate 12 is not a structural member of the foot board assembly 10. Rather, it is attached to the top plate 14 with the plurality of bolts 16 and does not directly come into contact with the band member 20 or the bottom plate 18. On the other hand, the top plate 14 includes a plurality of top plate projections 30 extending outwardly from the outer edge 21 of the top plate 14. These top plate projections 30 come into contact with the band member 20 and provide surfaces for welding or otherwise attaching the band member 20 to the outer edge 21 of the top plate 14, as will be more fully discussed below.

The cap plate 12 defines a first cap plate opening 26, a second cap plate opening 28, a third cap plate opening 29, a fourth cap plate opening 31, and a fifth cap plate opening 33. The first cap plate opening 26 comprises decorative indicia which in the illustrated embodiment is fanciful or ornamental lettering, thereby providing an aesthetically-pleasing appearance. In the illustrated embodiment the ornamental letters are the characters “FTW” which are interconnected to one another and disposed vertically, one letter on top of another. However other embodiments of the invention may include different letters or characters in other arrangements and fonts, as well as include other types of decorative indicia or designs. The second, third, fourth and fifth cap plate openings 28, 29, 31, 33 are geometrically-shaped and also provide a decorative, aesthetically-pleasing appearance.

As best seen in FIG. 3, the bottom plate 18 includes a plurality of bottom plate projections 32 extending outwardly from the outer edge 23 of the bottom plate 18. These bottom plate projections 32 come in contact with the band member 20 and provide surfaces for welding or otherwise attaching the band member 20 to the outer edge 23 of the bottom plate 18 so that the bottom plate 18 is in a generally parallel, spaced-apart relationship with the top plate 14. The bottom plate 18 defines a first bottom plate opening 34, a second bottom plate opening 35, a third bottom plate opening 37, a fourth bottom plate opening 39 and a fifth bottom plate opening 41. Each of these bottom plate openings are geometrically-shaped and provide a decorative, aesthetically-pleasing appearance.

FIG. 4 is a side elevation view of the foot board assembly 10 as viewed in an direction facing outwardly from the center of a motorcycle (not shown) when the foot board assembly 10 is mounted on the motorcycle. The cap plate 12 rests directly on the top plate outer surface 13 (FIG. 2) and is secured to the top plate 14 with the plurality of bolts 16. The bottom plate 18 is disposed in a generally parallel, spaced-apart relationship below the top plate 14. A plurality of spacer members or tabs 36 is located near the inward side of the foot board assembly 10 on the generally opposite side of the assembly 10 as the band member 20. As explained in further detail below, the tabs 36 are disposed between and connected to the top and bottom plates 14, 18 so as to maintain their spaced-apart relationship while adding structural strength to the box-like assembly, and providing a means for attaching the foot board assembly 10 to a motorcycle frame (not shown).

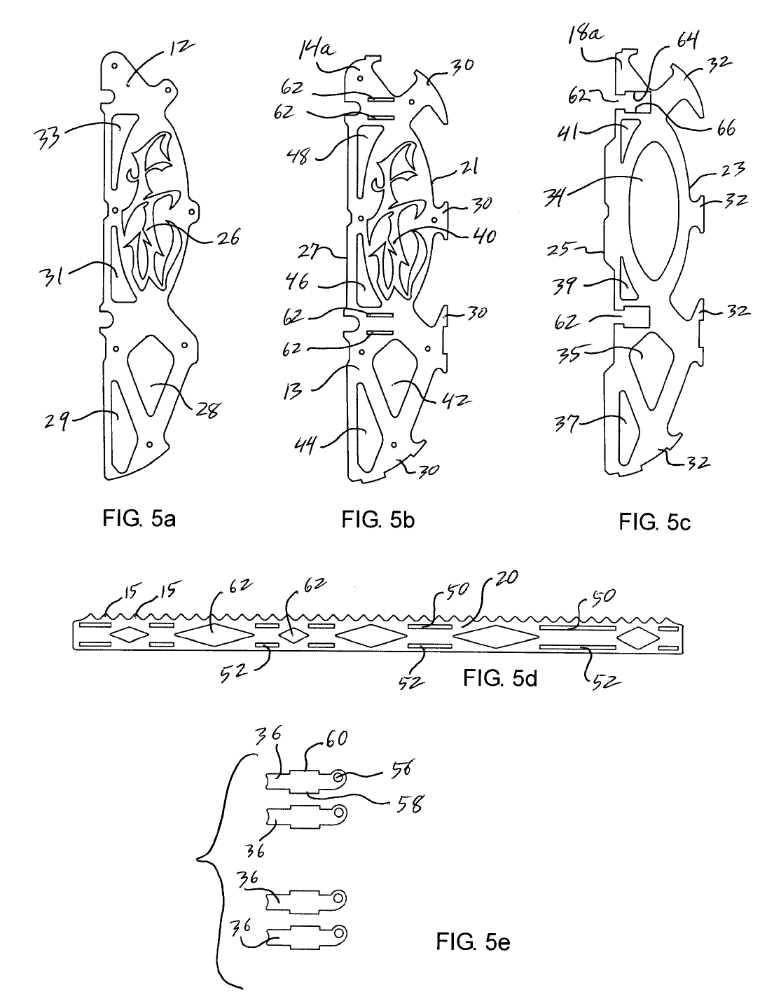

FIGS. 5a- 5e illustrate certain component parts of the foot board assembly 10 of FIG. 1 as they appear in their pre-assembled form. The top plate 14a (FIG. 5b) defines a first top plate opening 40, a second top plate opening 42, a third top plate opening 44, a fourth top plate opening 46, and a fifth top plate opening 48. The first top plate opening 40 comprises the same decorative indicia as the first cap opening 26 (FIG. 5a) and is in register with the first cap opening 26 so that when the cap plate 12 is mounted on the top plate 14a, these openings 26, 40 are in register or alignment and extend through the cap plate 12 and the top plate 14. Similarly, the second through the fifth top plate openings 42, 44, 46, 48 are in register with the second through the fifth cap openings 28, 29, 31, 33, respectively, so that each of these openings is in register or alignment with its counterpart and extends through the cap plate 12 and the top plate 14 when the cap plate 12 is mounted on the top plate 14a.

Referring now to FIG. 5c, the first bottom plate opening 34 of the bottom plate 18a is generally oval in shape and is in register with the first cap opening 26 and first top plate opening 40 when assembled. The generally oval shape of the first bottom plate opening 34 is a different shape than the decorative indicia of the first cap opening 26 and the first top plate opening 40. However the first bottom plate opening 34 is sized so as to be in register with and to “frame” the indicia-shaped cap and top plate openings 26, 40 when these pieces are assembled thus providing a view that extends entirely through the foot board assembly 10. (In alternative embodiments however the first bottom plate opening can comprise the same decorative indicia as the first top plate opening 40 and first cap opening 26.) On the other hand, the second bottom plate opening 35 is generally the same geometric shape and size as the second cap opening 28 and the second top plate opening 42. Thus another view is provided that extends entirely through the foot board assembly 10.

The third, fourth and fifth bottom plate openings 37, 39, 41 are somewhat different however. Each of these three openings 37, 39, 41 has generally the same geometric shape as, respectively, the third, fourth and fifth cap openings 29, 31, 33 and the third, fourth and fifth top plate openings 44, 46, 48. Also, each of these three bottom plate openings 37, 39, 41 is in register with, respectively, the third, fourth and fifth cap openings 29, 31, 33 and third, fourth and fifth top plate openings 44, 46, 48, so that when assembled three additional views that extend entirely through the foot board assembly 10 are provided. However each of the third, fourth and fifth bottom plate openings 37, 39, 41 is smaller in size than its corresponding cap plate opening and top plate opening. Portions of the bottom plate 18a therefore can be seen when viewed from the top of the foot board assembly 10 (as best seen in FIGS. 1 and 2), thus providing an aesthetically-pleasing, three-dimensional visual effect.

Thus the first through the fifth cap plate openings 26, 28, 29, 31, 33, the first through the fifth top plate openings 40, 42, 44, 46, 48, and the first through the fifth bottom plate openings 34, 35, 37, 39, 41 not only provide a decorative effect, but also result in a foot board assembly that is lighter in weight as a result of the lesser amount of material required to form the assembly.

Still referring to FIG. 5c, the bottom plate 18a further defines a plurality of openings or mouths 62 extending into the inner side or inner edge 25 of the bottom plate 18a, i.e., the side of the bottom plate 18a that is generally opposite the plurality of bottom plate projections 32. Each mouth 62 is further defined by a first mouth edge 64 and a second mouth edge 66. The first edge 64 is disposed in a generally transverse direction with respect to the longitudinal axis of the bottom plate 18a, and the second mouth edge 66 runs generally parallel with the first edge 64 on the opposite side of the mouth 62. As discussed in further detail below, these edges 64, 66 provide a surface for attaching the tabs 36 during assembly.

FIG. 5d depicts the band member 20 in its pre-assembled form which is in a generally straight shape. (The generally curved end portions 24 as shown in FIG. 1 are formed as the band member 20 is bent for attaching it to the top plate 14 and bottom plate 18.) The band member 20 includes a first plurality of band openings or slits 50 arrayed along and adjacent to the upper longitudinal edge of the band member 20. These slits 50 are dimensioned and adapted to receive a portion of each of the plurality of top plate projections 30 during assembly. The band further includes a second plurality of band openings or slits 52 arrayed along and adjacent to the opposite, lower longitudinal edge of the band member 20. These slits 52 are similarly dimensioned to receive a portion of each of the plurality of bottom plate projections 32 during assembly. After the top and bottom plate projections 30, 32 are inserted into the first and second plurality of slits 50, 52, respectively, these projections 30, 32 are welded or otherwise secured to the band member 20. Any portions of the projections 30, 32 that may thereafter protrude from the outer surface of the band member 20 can be removed by grinding or other processes so that a smooth exterior surface of the band member 20 remains.

The band member 20 further defines a plurality of larger, geometrically-shaped band openings 62 disposed along the length of the band member 20. In the illustrated embodiment, the openings are geometrical in shape thereby providing an aesthetically-pleasing appearance while reducing the weight of the band member 20 as a result of the lesser amount of material used in forming the band member 20. However other embodiments of the invention may include openings having other shapes as well.

The plurality of spacer members or tabs 36 (FIG. 5e) are each generally longitudinal in shape and define a tab opening 56 at one end of the tab 36. The tabs 36 are dimensioned so that they can be disposed between and connected to the top plate 14 and bottom plate 18. That is, each of the tabs 36 has a width that corresponds to the distance by which the top plate 14a is to be separated from the bottom plate 18a. Thus as best seen in FIG. 4, the tabs 36 assist in providing a spatial separation between the top and bottom plates 14, 18 and in providing structural strength for the foot board assembly 10.

Referring again to FIG. 5e, each tab 36 includes a first ear 58 protruding from one longitudinal edge of the tab 36 and a second ear 60 protruding in the opposite direction from the other longitudinal edge of the tab 36. The first ear 58 is dimensioned and adapted to mate with one of a plurality of top plate slits 62 extending through the top plate 14a (FIG. 5b) in a direction that is generally transverse to its longitudinal axis and at a location adjacent to the inner edge 27 of the top plate 14a. Similarly, the second ear 60 is dimensioned and adapted to abut the first mouth edge 64 or the second mouth edge 66, as the case may be, located adjacent to the inner edge 25 of the bottom plate 18a (FIG. 5c).

The plurality of first ears 58 can then be welded or otherwise attached to the top plate 14a at the location of the top plate slits 62. Any excess material extending above the top plate outer surface can be ground away or otherwise removed to provide a smooth surface. Similarly, the plurality of second ears 60 can be welded or otherwise attached to the bottom plate 18a at the locations of the first or second mouth edges 64, 66. Again, any excess material extending below the bottom plate can be ground away or otherwise removed to provide a smooth surface. When thus assembled, the tab openings 56 are oriented inwardly and generally laterally from the longitudinal axis of the foot board assembly 10 for use in mounting it to a motorcycle frame (not shown).

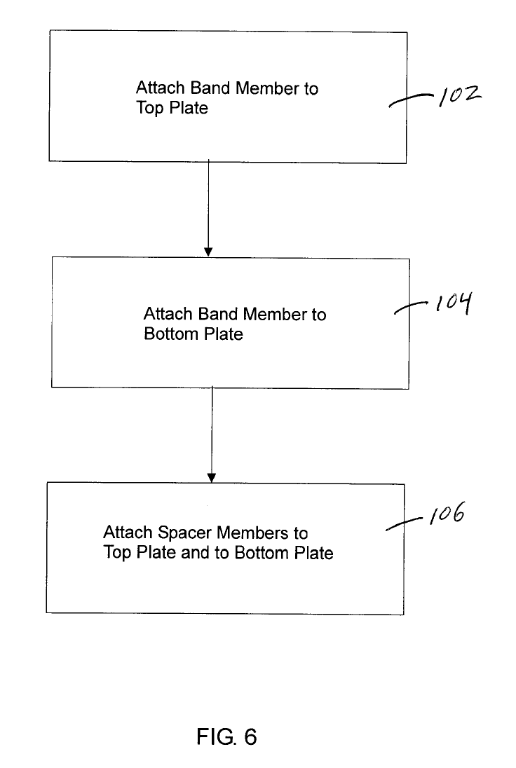

FIG. 6 depicts a simplified process flow diagram for a method of making a foot board assembly in accordance with one embodiment of the invention. First, a band member is attached to an outer edge of a first or top plate. (Step 102) According to one embodiment, this is achieved by inserting a plurality of projections of the top plate into a plurality of openings in the band member and welding the projections to the band member. Next, the band member is attached to an outer edge of a second or bottom plate. (Step 104) This similarly is achieved by inserting a plurality of projections of the bottom plate into another plurality of openings in the band member and welding the projections to the band member. A plurality of spacer members are attached to the top and bottom plates so that the spacer members are disposed between them. (Step 106). This is achieved by inserting one ear of each spacer member into a slit in the top plate and welding that ear to the top plate. Then another ear of each spacer member is made to abut an edge of an opening in the bottom plate and is welded to the bottom plate at that location. When completed the top plate is in a generally spaced-apart relationship with the bottom plate thereby forming a generally box-shaped structure.

In view of the above, therefore, it will be appreciated that embodiments of the invention provide an apparatus for supporting the foot of an operator. A foot board assembly comprises a box-like structure having a greater strength, yet is relatively light in weight due to a plurality of openings extending through the assembly and providing an aesthetically-pleasing appearance. A band provides structural strength as well as an outer wall having a plurality of teeth thereby allowing for safety and grip for the operator's foot.

While the description above refers to particular embodiments of the present invention, it will be understood that many modifications may be made without departing from the spirit thereof. The claims are intended to cover such modifications as would fall within the true scope and spirit of the present invention. The presently disclosed embodiments are therefore to be considered in all respects as illustrative and not restrictive, the scope of the invention being indicated by the claims rather than the foregoing description, and all changes which come within the meaning and range of equivalency of the claims are therefore intended to be embraced therein.

What is claimed is:

1. A foot board assembly for use with a vehicle and for use by an operator having an operator's foot, the foot board assembly comprising:
a first plate dimensioned to support the operator's foot, wherein the first plate has a first plate outer edge and a first plate inner edge;
a second plate disposed in a spaced-apart relationship from the first plate, wherein the second plate has a second plate outer edge and a second plate inner edge; and
a band member connected to the first plate outer edge and the second plate outer edge;
wherein the foot board assembly is generally box-shaped.

2. The foot board assembly of claim 1 wherein the first plate defines a first plate opening, wherein the second plate defines a second plate opening, and wherein the first plate opening is in register with the second plate opening.

3. The foot board assembly of claim 2 wherein the first plate opening has a first shape comprising a first decorative indicia.

4. The foot board assembly of claim 1 wherein the first plate includes an inner surface disposed proximate to the second plate and an outer surface disposed distal to the second plate, the foot board assembly further comprising a third plate disposed on the outer surface of the first plate.

5. The foot board assembly of claim 4 wherein the first plate defines a first plate opening, wherein the second plate defines a second plate opening, wherein the third plate defines a third plate opening, and wherein each of the first plate opening, the second plate opening and the third plate opening is in register with one another.

6. The foot board assembly of claim 5 wherein the first plate opening has a first shape comprising a first decorative indicia, wherein the second plate opening has a second shape comprising a second decorative indicia, wherein the third plate opening has a third shape comprising a third decorative indicia, and wherein each of the first decorative indicia, the second decorative indicia and the third decorative indicia is generally the same in appearance.

7. The foot board assembly of claim 5 wherein the first plate opening has a first shape comprising a first decorative indicia, wherein the second plate opening has a second shape, wherein the third plate opening has a third shape comprising a third decorative indicia, wherein each of the first decorative indicia and the third decorative indicia is generally the same in appearance, and wherein the second shape is different in appearance than the first decorative indicia and the third decorative indicia.

8. The foot board assembly of claim 1 wherein the first plate includes an inner surface disposed proximate to the second plate and an outer surface disposed distal to the second plate, and wherein the band member extends above the outer surface.

9. The foot board assembly of claim 8 wherein the band member further includes a plurality of teeth extending above the outer surface of the first plate.

10. The foot board assembly of claim 1 wherein the first plate includes a first plate projection, wherein the second plate includes a second plate projection, wherein the band member defines a first opening dimensioned to receive at least a portion of the first plate projection, and wherein the band member further defines a second opening dimensioned to receive at least a portion of the second plate projection.

11. The foot board assembly of claim 1 further comprising a spacer member disposed between the first plate and the second plate and connected to the first plate and the second plate.

12. The foot board assembly of claim 11 wherein the spacer member is generally longitudinal in shape and defines a spacer member opening at one end of the spacer member, and wherein the spacer member opening is dimensioned for engagement onto the vehicle.

13. The foot board assembly of claim 11 wherein the first plate defines a first plate slit, wherein the spacer member includes an ear extending from the spacer member, and wherein the first plate slit is dimensioned to receive the ear.

14. The foot board assembly of claim 11 wherein the second plate defines a second plate opening having an edge, wherein the spacer member includes an ear extending from the spacer member, and wherein the ear is dimensioned to abut the edge.

15. The foot board assembly of claim 1 wherein the vehicle is one of a motorcycle, a bicycle and a tricycle.

16. A foot board assembly for securing to a vehicle and for use by an operator having an operator's foot, the foot board assembly comprising:
a first plate dimensioned to support the operator's foot, wherein the first plate has a first plate outer edge and a first plate inner edge;
a second plate disposed in a spaced-apart relationship from the first plate, wherein the second plate has a second plate outer edge and a second plate inner edge,
wherein the first plate includes an inner surface disposed proximate to the second plate and an outer surface disposed distal to the second plate;
a band member connected to the first plate outer edge and the second plate outer edge, wherein the band member extends above the outer surface of the first plate; and
a spacer member disposed between the first plate and the second plate and connected to the first plate and the second plate.

17. The foot board assembly of claim 16 wherein the first plate defines a first plate opening, wherein the second plate defines a second plate opening, and wherein the first plate opening is in register with the second plate opening.

18. The foot board assembly of claim 16 wherein the first plate includes a first plate projection, wherein the second plate includes a second plate projection, wherein the band member defines a first opening dimensioned to receive at least a portion of the first plate projection, and wherein the band member further defines a second opening dimensioned to receive at least a portion of the second plate projection.

19. A foot board assembly for securing to a vehicle and for use by an operator having an operator's foot, the foot board assembly comprising:
a first plate dimensioned to support the operator's foot, wherein the first plate has a first plate outer edge, a first plate inner edge, and a first plate projection extending from the first plate outer edge;
a second plate disposed in a spaced-apart relationship from the first plate, wherein the second plate has a second plate outer edge, a second plate inner edge, and a second plate projection extending from the second plate outer edge;
wherein the first plate includes an inner surface disposed proximate to the second plate and an outer surface disposed distal to the second plate;
a band member defining a first member opening and a second member opening, wherein at least a portion of the first plate projection extends into the first member opening and at least a portion of the second plate projection extends into the second member opening, and wherein the band member extends above the outer surface of the first plate; and
a spacer member disposed between the first plate and the second plate and connected to the first plate and the second plate,
wherein the first plate defines a first plate opening, wherein the second plate defines a second plate opening, and wherein the first plate opening is in register with the second plate opening.

20. A method of making a foot board assembly comprising the steps of:
attaching a band member to an outer edge of a first plate;
attaching the band member to an outer edge of a second plate; and
attaching a spacer member to the first plate and to the second plate so that the spacer member is disposed between the first plate and the second plate,
wherein the first plate is disposed in a spaced-apart relationship with the second plate.

21. The method of claim 20 wherein the first plate defines a first plate opening, wherein the second plate defines a second plate opening, and wherein the first plate opening is in register with the second plate opening.

22. The method of claim 20 wherein the first plate includes an inner surface disposed proximate to the second plate and an outer surface disposed distal to the second plate, and wherein the band member extends above the outer surface.

23. The method of claim 22 wherein the band member further includes a plurality of teeth extending above the outer surface.

24. The method of claim 20 wherein the first plate includes a first plate projection, wherein the second plate includes a second plate projection, wherein the band member defines a first opening and a second opening,
wherein the step of attaching the band member to the outer edge of the first plate includes inserting at least a portion of the first plate projection into the first opening, and
wherein the step of attaching the band member to the outer edge of the second plate includes inserting at least a portion of the second plate projection into the second opening.
